(19) United States
(12) Patent Application Publication
(10) Pub. No.: US 2005/0209897 A1
(43) Pub. Date: Sep. 22, 2005

(54) Builder risk assessment system

(76) Inventor: Stanley R. Luhr, El Cajon, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/802,129

(22) Filed: Mar. 16, 2004

(51) Int. Cl. G06F 17/60

(52) U.S. Cl. 705/7

(57) ABSTRACT

A builder risk assessment system that assesses the quality of a builder's operations is disclosed. In various embodiments, the system assesses the builder on a variety of quality measures that are deemed to be associated with potential risk and determines an overall risk assessment for the builder that may be expressed, for example, as a numerical score, a grade, or an assigned tier-level. In various embodiments, the assessment considers factors such as design quality, builder knowledge, communications systems, customer service, data tracking, prior and active claims, safety programs, and legal/contractual/insurance issues. The builder risk assessment system may use responses to questions related to the factors and results from field inspections of the builder's construction sites to generate the risk assessment. The builder risk assessment system may select the questions and inspection checkpoints based on a consideration of characteristics of the builder's operations, such as size, type, and geographical location of the builder's construction projects so that the assessment may be customized and may be used to meaningfully compare the builder's quality and risk relative to that of other builders.

### BACKGROUND OF THE INVENTION

1. Field of the Invention

The present invention relates generally to risk assessment, and more specifically, to a risk assessment performed for a builder in the construction industry.

2. Description of the Related Art

Litigation associated with defects in building construction has been rising in recent years. As the number of construction-related claims submitted and the amounts of awards granted in these cases continue to increase, builders and their insurance companies find themselves exposed to ever greater financial risk.

To some extent, a builder's characteristic business practices and construction quality practices can be used to predict the likelihood that the builder will become involved in construction-related claims or litigation. Identifying a builder's predicted level of risk could be valuable to a variety of parties, among them insurance companies who are considering insuring the builder. However, there is no easy way to distinguish between high-risk builders and low-risk builders because no standardized measure exists in the building industry to express a level of risk involved in insuring a builder.

Furthermore, there is not typically any standardized way for a builder to self-assess regarding construction quality and exposure to risk. In addition, a potential customer, insurer, or risk partner generally cannot “comparison shop” the true hidden quality of a builder other than anecdotally or by making a more indirect assessment using other measures such as profit levels, payments made due to defects claims, and the like. No standardized measure currently exists to allow a builder to measure progress made towards risk-reduction or to self-compare with the risk-levels of other similar builders. Builders constructing different types of structures in different geographic areas further complicate any comparison, since different locations and building complexities create disparate comparison opportunities.

In the face of this uncertainty, everyone involved typically pays the cost. For example, insurance companies evaluate builder risk without the benefit of a standardized measurement tool. High-quality and low-quality builders alike may be charged higher insurance premiums to cover costs incurred by builders who do become involved in defect-related claims, and price increases, along with uncertain construction quality, may ultimately be passed along to consumers.

### SUMMARY OF THE INVENTION

The present invention provides a builder risk assessment system that assesses the quality of a builder's operations and that may be used to advise builders, their insurers, and/or other interested parties of anticipated risk associated with the builder's operations. The system may furthermore be used as an educational and quality assurance tool to identify areas of weaknesses and of strengths in the builder's operations and to assess progress towards improvement. In addition, the system may be used as a standardized tool for comparing the quality of builders relative to one another. Further, the system may be used to compare disparate projects and compare the builder's ability to properly construct them with other types of projects in different locales.

In one embodiment, the builder risk assessment system is implemented as a computer-based system that accepts input, guides the assessment processes, and produces a builder risk assessment score. An input interface in the builder risk assessment system receives preliminary information about a builder and about the builder's projects and transmits the preliminary information to a scorecard generation engine. The scorecard generation engine uses a set of customization rules to generate a customized plan for the builder risk assessment, based at least in part on characteristics of the builder and the builder's project(s) as disclosed by the builder data input.

The customization rules direct the scorecard generation engine to access a database comprising a master set of questions for assessing a variety of factors relevant to builder risk assessment in general and to select a subset of the questions that apply to the construction conditions and materials to be used in the builder's project(s). The customization rules further direct the scorecard engine to access a database comprising information about a wide variety of possible inspection checkpoints that may be used to guide a physical inspection of one or more construction sites associated with the builder. The scorecard engine selects a subset of relevant inspection checkpoints and creates a customized inspection list for the risk assessment. The system accepts input in response to the selected questions and inspection checkpoints and uses the input to “grade” the builder on a variety of quality measures that are deemed to be associated with potential risk and determines an overall risk assessment for the builder.

More particularly, the scorecard generation engine may select a set of questions and inspection checkpoints (“quality measures”) that are customized, based on characteristics of the builder's operations and projects, for use in assessing the builder. Thus, issues relevant to the type, location, construction style, and size of the project, among other project characteristics, may be used to customize the assessment. For example, questions and checkpoints used to assess a builder of detached single-family homes may differ from questions and checkpoints used to assess a builder of high-rise condominiums because in each of these types of projects, different risk, construction quality, legal, and other relevant issues exist.

By customizing assessment methods, embodiments of the system described herein allow for a more meaningful comparison of a builder across project types. An insurer or other interested party may thus more easily and accurately identify better-quality and lower-risk builders, who deserve to be in preferred categories of underwriting, and may, conversely, identify builders associated with higher risk.

In various embodiments, the system combines field measures obtained from physical inspections of the builder's construction sites with information gathered about other aspects of the builder's operations. For example, in one embodiment, a builder risk assessment score is determined based on an examination of the builder's construction practices as well as on an assessment of factors such as: design quality, builder knowledge, communications systems, customer service, data tracking, prior and active claims, safety programs, and legal/contractual/insurance issues.

The builder risk assessment system may determine numerical scores for factors that are components in the risk assessment and may use the component scores to calculate an overall risk assessment score for the builder. The numeric scores may be expressed as a percentage, as a value within a known range of scores, as a gradient score or other numeric method for expressing an assessment result. In some embodiments, categories, grades, or ranges may be used for the factors and/or for the overall risk assessment score in place of, or in addition to, numerical scores to express a level of risk. For example, in one embodiment, a multi-tiered system is used to express a builder's quality with respect to individual risk assessment factors, as well as to express an overall risk score, with better builders being assigned to higher tier levels.

An embodiment of a system for determining a builder risk assessment score is described. The system comprises a user interface for user entry of data regarding a builder and building projects associated with the builder; a database comprising a master set of questions and inspection checkpoints for conducting builder risk assessments; a first component configured to receive from the user interface the data regarding the builder and the builder's projects and to select from the database a subset of questions to present to the builder, and a subset of inspection checkpoints to use to inspect construction the builder; and a second component that calculates a risk assessment score for the builder based at least in part on builder responses to the subset of questions and results of the subset of inspection checkpoints.

An embodiment of a computer-implemented method for generating a risk assessment of a builder is described. The method comprises the act of providing a database that stores a master set of questions and inspection checkpoints for use in assessing builder risk. The method further comprises obtaining input about a builder and about projects associated with the builder. Furthermore, the method comprises using the input about the builder and the projects to select a subset of questions from the database to present to the builder, and a subset of inspection checkpoints to use to inspect one or more construction projects of the builder. The method also comprises the acts of: receiving responses to the subsets of questions from the builder, and storing the responses within computer storage; recording within the computer storage results of the subset of inspection checkpoints as applied to one or more construction projects of the builder; and using at least the responses to the subsets of questions and the results of the subset of inspection checkpoints to generate a risk assessment score of the builder.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

A general architecture that implements various features of the invention will now be described with reference to the drawings. The drawings and the associated descriptions are provided to illustrate embodiments of the invention and not to limit the scope of the invention. Throughout the drawings, reference numbers are re-used to indicate correspondence between referenced elements.

FIG. 1 is a block diagram that depicts one embodiment of a system for providing a builder risk assessment.

FIG. 2 depicts factors that influence one embodiment of a builder risk assessment scoring.

FIG. 3 is a flowchart that depicts one embodiment of a process to generate a builder risk assessment report and a builder risk assessment score.

FIG. 4 is a flowchart that depicts one embodiment of a process for selecting a set of checkpoints for a builder risk assessment.

FIG. 5 is a flowchart that depicts one embodiment of a process to conduct a set of field inspections and generate a process component risk score for a builder risk assessment.

### DETAILED DESCRIPTION OF THE PREFERRED EMBODIMENT

A builder risk assessment system that assesses the quality of a builder's operations is disclosed. In various embodiments, the system assesses the builder on a variety of quality measures that are deemed to be associated with potential risk. The builder risk assessment system determines an overall risk assessment for the builder that may be expressed, for example, as a numerical score, a grade, or an assigned tier-level. In various embodiments, the assessment considers factors such as design quality, builder knowledge, communications systems, customer service, data tracking, prior and active claims, safety programs, and legal/contractual/insurance issues.

In one embodiment, the builder risk assessment system is implemented as a computer-based system that accepts input, guides the assessment processes, and produces a builder risk assessment score. An input interface in the builder risk assessment system receives preliminary information about a builder and about the builder's projects and transmits the preliminary information to a scorecard generation engine. The scorecard generation engine uses a set of customization rules to generate a customized plan for the builder risk assessment, based at least in part on characteristics of the builder and the builder's project(s) as disclosed by the builder data input.

The customization rules direct the scorecard generation engine to access a database comprising a master set of questions for assessing a variety of factors relevant to a builder risk assessment and to select a subset of the questions. The customization rules further direct the scorecard engine to access a database comprising information about a wide variety of possible inspection checkpoints that may be used to guide a physical inspection of one or more construction sites associated with the builder. The scorecard engine selects a subset of the inspection checkpoints and creates a customized inspection list for the risk assessment. The system accepts input in response to the selected questions and inspection checkpoints and uses the input to “grade” the builder on a variety of quality measures that are deemed to be associated with potential risk and determines an overall risk assessment for the builder.

A risk assessment for a builder may be requested by the builder, by an insurer or a potential insurer of the builder, by a financial partner or suitor, by a potential purchaser or customer of the builder, by a potential lender, by a governmental body, such as a county licensing board, as requirement of membership in a professional association, or by a variety of other entities and for a variety of other uses. For example, the risk assessment may be an annual requirement of an insurer or other interested party.

For purposes of this disclosure, the builder risk assessment system is described as assessing a builder, which may be an individual, a company, one or more divisions of a company, or other business entity whose operations comprise, at least in part, the construction of improvements to real property. A builder is described herein as a developer or general contractor responsible for the overall construction of a building project, such as a condominium complex, a shopping center, or tract of homes. However, embodiments of the systems and methods described herein may also be used to assess risk associated with other entities associated with the construction industry, such as for sub-contractors, individual tradesmen, associations of sub-contractors, design professionals, products and material suppliers, and the like.

Furthermore, a builder risk assessment may be conducted with respect to a set of existing or known upcoming construction projects associated with the builder. For example, an insurer that has been approached by the builder for an insurance quote may request that the builder obtain a risk assessment and may use the results of the risk assessment to more accurately determine an appropriate insurance quote. Thus, if the assessment is being performed at the request of an insurer, the assessment may address issues related to those of the builder's operations and projects for which the builder is requesting insurance, which may comprise one project, all projects, or a subset of the projects in which a builder is involved. In some embodiments, a new risk assessment may be performed when a builder embarks on a project of a type or geographic location that is new to the builder.

When a builder is involved with several projects, the risk assessment may be performed for a subset of the projects determined to be representative of the builder's operations. The size of the subset may be selected based on a total number of projects associated with the builder so that the subset may provide a statistically accurate sample of the builder's operations. Risk assessed at the individual projects may be weighted and combined to determine one combined risk assessment score for the builder as a whole, or for a division or company of the builder.

The risk assessment may also be used for projects not yet constructed, utilizing a builder's history of performance on similar projects and analyzing the design documents of a proposed project, applying similar review protocols as for existing projects.

As will be described in greater detail below, the assessment may be customized to assess risk associated with specific projects or types of projects in which the builder is involved. In some embodiments, if the builder is involved in multiple disparate types of projects, individual assessments may be performed for the various types of projects, or one combined assessment may be performed. If a builder requests overall assessment of the builder's operations, for both those that are currently known or those that are not known, typical types of projects in which the builder is involved may be assessed.

As will be familiar to a practitioner of ordinary skill in the art, the builder risk assessment system described herein may be used to assess risk associated with a builder's operations and/or to assess the quality of a builder's operations, in particular with respect to other builders and/or with respect to the builder's own past performance.

The builder risk assessment described herein may be conceptualized as a customized “scorecard” of questions and inspection checkpoints that are designed as a tool for obtaining relevant data for an assessment of the builder and of the projects in question. In the embodiments described herein, the builder assessment procedure may be customized, based on a variety of factors that are descriptive of the builder and, more particularly, of the type of construction project and geographic risks for which the builder is being assessed. This customization allows for examination of issues that may be more relevant to one type of construction than to another and that may be more relevant to environmental demands of one region over another. Thus, a builder who is planning to build a small condominium complex in Southern California may be assessed according to a different set of questions and inspections than a builder for a large development of single-family dwellings in Northern Michigan.

Furthermore, the customization may be seen as a type of standardization, because builders working on similar projects under similar geographical conditions may be rated based on a similar set of questions and checkpoints, thus allowing for a standardized assessment of builders and their projects as well as the possibility of a more meaningful comparison of builders across a variety of project types.

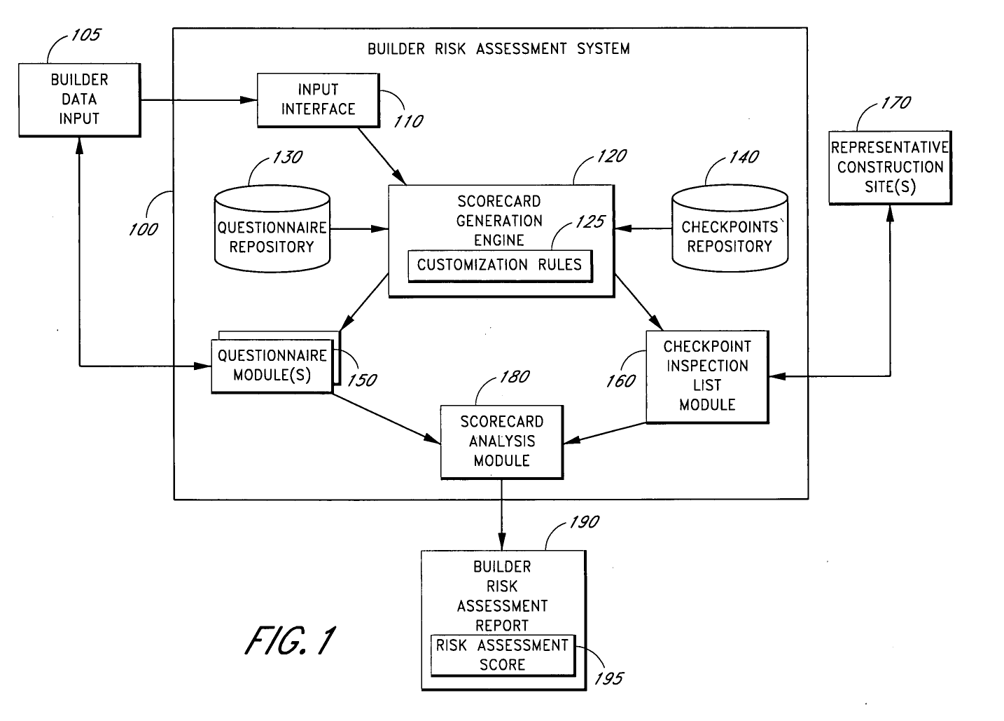

FIG. 1 is a block diagram that depicts one embodiment of a system for generating a builder risk assessment. As shown in FIG. 1, a builder risk assessment system 100 receives builder data input 105 as well as information from one or more representative construction sites 170 in order to generate a builder risk assessment report 190 that comprises a builder risk assessment score 195.

The builder risk assessment system 100 may be implemented as a computer system comprising, by way of example, processors, program logic, or other substrate configurations that represent data and instructions and that operate as described herein. In some embodiments, the processors may comprise, by way of example, personal computers (PCs), mainframe computers, other processors, controller circuitry, processor circuitry, general purpose single-chip or multi-chip microprocessors, digital signal processors, embedded microprocessors, microcontrollers, and the like.

Furthermore, the program logic may be implemented as one or more modules that may comprise at least one of the set of software or hardware components consisting of: object-oriented software components, class components, task components, processes, methods, functions, attributes, procedures, subroutines, segments of program code, drivers, firmware, microcode, circuitry, data, databases, data structures, tables, arrays, and variables.

The builder risk assessment system 100 and the builder data input module 105 may be configured to communicate using a medium that transmits and receives messages via the Internet or other network of computers. In various embodiments, the builder risk assessment system 100 and the builder data input module 105 are configured to communicate using a communications medium that may comprise, by way of example, dial-up network connection, Virtual Private Network (VPN), dedicated communication lines such as T1 or frame relay for host-to-host connection, or other combination of dial-up telephone networks, wireless data transmission systems, two-way cable systems, customized computer networks, automatic teller machine networks, interactive television networks, and the like. In other embodiments, the builder risk assessment system 100 and the builder data input module 105 communicate using other automated wireless or infrared technologies.

In some embodiments, a builder may submit data to the builder risk assessment system 100 on paper, via telephone, via computer network, or at a face-to-face interview, and the builder data input 105 may be entered into the builder risk assessment system 100 using at least one of an automated voice recognition system, a character recognition system, or by a representative of the builder risk assessment system 100. In some embodiments, a representative of the builder risk assessment system 100 may perform an investigation, such as a review of the builder's documentation procedures and computer systems, to verify the accuracy of some or all of the builder data input 105 or to compare recently acquired data with historical data stored in an electronic database.

The builder data input 105 comprises preliminary information that characterizes and identifies the builder and the specific project for which the builder is seeking assessment. An input interface 110 in the builder risk assessment system 100 receives the preliminary information and transmits the preliminary information to a scorecard generation engine 120. The scorecard generation engine 120 uses a set of customization rules 125 to generate a customized plan for the builder risk assessment, based at least in part on characteristics of the builder and the builder's project(s) as disclosed by the builder data input.

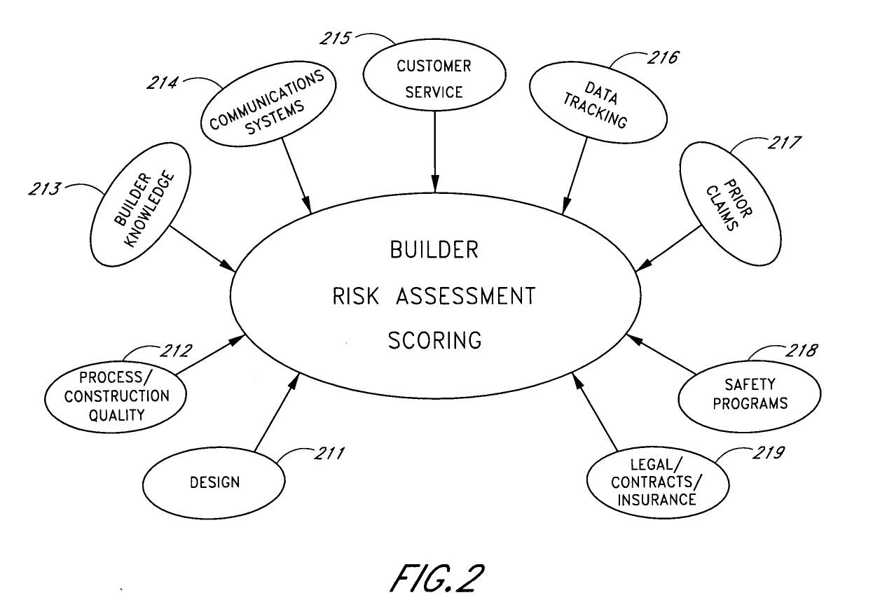

The customization rules 125 direct the scorecard generation engine 120 to access a questionnaire repository 130. The questionnaire repository 130 stores a master set of questions for assessing a variety of factors relevant to a builder risk assessment that will be described in greater detail with reference to FIG. 2. For example, the questionnaire repository 130 may store questions that help assess a builder's customer service policies, safety programs, communications and data tracking systems, historical exposure to claims of defective construction, and other factors that may be indicative of a builder's exposure to risk.

Based at least in part on the preliminary information received as builder data input 105, the customization rules 125 direct the scorecard generation engine 120 to compile a subset of the questions in the questionnaire repository 130 in order to generate one or more questionnaire modules 150 comprising questions that are relevant to the project type, geographic location, and other characteristics of the builder being assessed in the current assessment.

As depicted in the embodiment of FIG. 1, the builder risk assessment system 100 may obtain responses to the one or more questionnaire modules 150 as further builder data input 105. As was described with respect to preliminary builder data input, the responses to the questionnaire modules 150 may be obtained using at least one of: computer network, paper submission, telephone or personal interview, or other data acquisition methods. The responses received by the questionnaire module 150 may be electronically inputted and transmitted to a scorecard analysis module 180 for inclusion in generating a builder risk assessment report that comprises a builder risk assessment score 195, as will be described in greater detail below.

The customization rules 125 further direct the scorecard generation engine 120 to access a repository of construction site inspection checkpoints 140 comprising information about a master set of inspection checkpoints that may be used to visually examine the quality of builders' construction practices and any associated exposure to risk and/or monetary claims, covering issues that may arise for a variety of construction project types in a variety of geographic locations. In various embodiments, the information stored about a given checkpoint in the checkpoints repository 140 may comprise information about at least one of: proper construction practices associated with the checkpoint, statistical information about the frequency and cost of problems associated with the checkpoint, the relative importance of the checkpoint to a risk assessment for construction projects associated with a variety of characteristics, such as building type, geographical location, specific construction materials or products, and the like. In other embodiments, other checkpoint information may additionally or alternatively be stored in the checkpoints repository 140.

In various embodiments, based at least in part on the preliminary information received as builder data input 105, the customization rules 125 direct the scorecard generation engine 120 to compile a subset of the checkpoints from the checkpoint repository 140 in order to generate a customized checkpoint inspection list 160 for guiding an inspection of at least one construction site that is demonstrative of the builder's construction quality for the type, location, and other characteristics of the project being assessed.

As depicted in the embodiment of FIG. 1, the checkpoint inspection list module 160 obtains responses to the checkpoint inspection list 160 from inspectors who visit one or more representative builder construction sites 170. The responses received by the questionnaire module 150 and by the checkpoint inspection list module 160 may be transmitted to a scorecard analysis module 180 for generating a builder risk assessment report that comprises a builder risk assessment score 195.

FIG. 1 depicts one embodiment of a system to perform builder risk assessments. As will be familiar to one of ordinary skill in the art, other embodiments of the system to perform builder risk assessments may be implemented with other configurations of system components and/or other divisions of functions to be performed without departing from the intended spirit of the invention as described herein. For example, in FIG. 1, the questionnaire repository 130 and the checkpoint repository 140 are depicted as discrete repositories. In other embodiments the questionnaire repository 130 and the checkpoint repository 140 may be stored in a database of information accessible by the scorecard generation engine 120. Other components of the builder risk assessment system 100 may be configured differently than depicted in FIG. 1 without departing from the spirit of the invention.

FIG. 2 depicts factors that influence one embodiment of a builder risk assessment scoring system. As depicted in the embodiment shown in FIG. 2, factors that may be used to determine a builder risk assessment score include: design 211, process/construction quality 212, builder knowledge 213, communications/systems 214, customer service 215, data tracking 216, prior claims 217, safety programs 218, and legal contracts/insurance 219. Assessing a builder on the factors 211-219 allows the system 100 to generate a comprehensive builder risk assessment score 195 that is indicative of a builder's exposure to financial risk that may result from at least one of a variety of known causes associated with executing construction projects.

Describing the factors of this embodiment in greater detail, the design factors 211 refer to an assessment of aspects of the architectural and other design plans associated with the builder's projects that may be known to be associated with exposure to subsequent financial risk or other claims of liability. In some embodiments, the assessment may examine the quality of the design, the completeness of the design documents, and the integration of design considerations throughout the course of a project, among other considerations.

In some embodiments, assessment of design factors 211 is implemented by the creation of a customized questionnaire of design-related questions for response by the builder. For example, the customized questionnaire may present questions such as: Is the design architect for the project contracted to conduct onsite observations during the construction phase of the project? Does the architect preview model homes while the inner structure of the construction is still visible to identify weaknesses and conflicts in design? Does an engineer associated with the project have an opportunity to resolve structural problems during construction?

In some embodiments, assessment of design-related factors 211 is implemented by an examination of the plans themselves, which may be executed by a suitably configured computer program, by a sufficiently knowledgeable examiner, or by a combination of the two. The examination of the plans may, for example, assess design conflicts that, if built, may reduce the safety, durability, comfort and/or efficiency of a building; cause damage or code violation; create product conflicts and/or incompatibilities; include products or installations known to be defective for the specified use; and insufficiency of design detail. The examination may also reveal risks associated with omissions or errors in contract documents.

In various embodiments, the use of a design-related questionnaire and/or examination of design documents may be customized to assess design aspects known to be relevant for the type or types of projects being assessed.

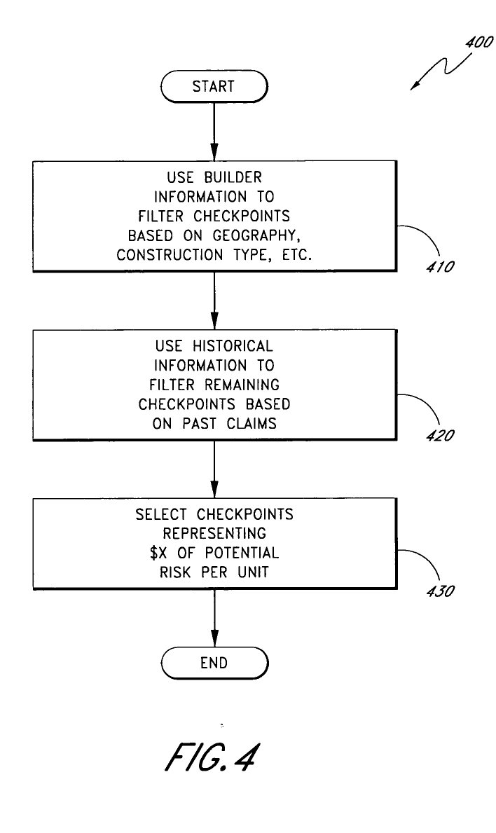

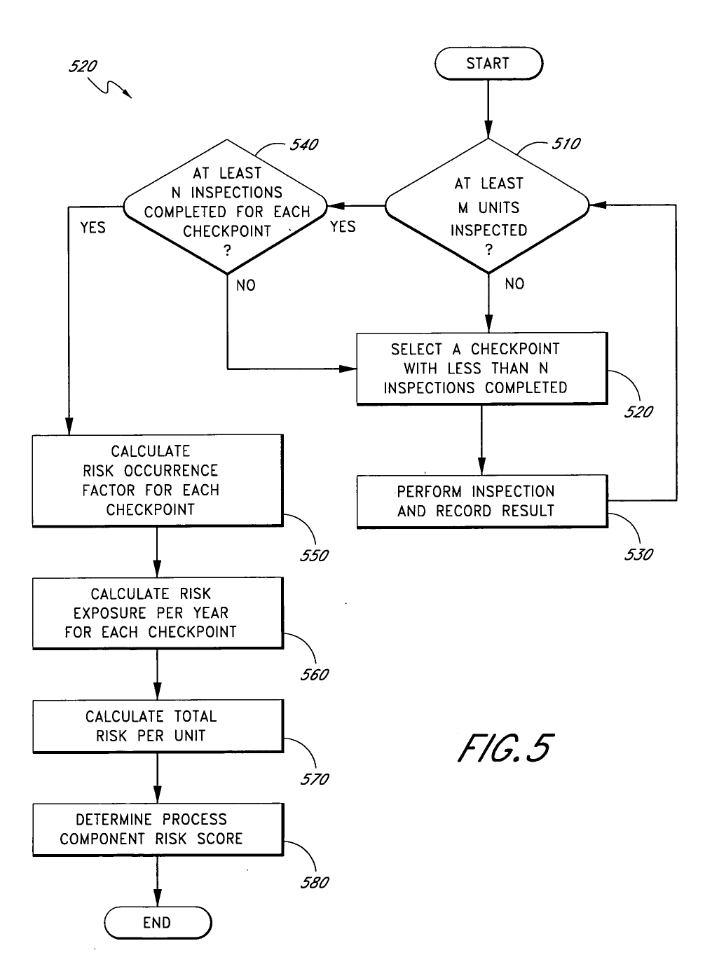

The process/construction quality factors 212 refer to an assessment of the builder's construction practices as evidenced by physical inspection of one or more actual building sites 170 associated with the builder. As will be described in greater detail with reference to FIG. 4 and FIG. 5, the builder risk assessment system 100 identifies a set of inspection checkpoints that are customized for the builder type and project type being assessed. The identified checkpoints represent a selection of construction defects that may commonly result in financial or other liability and thus may be deemed to be predictive of potential risk associated with the project.

The builder knowledge factors 213 of the risk assessment scoring process may relate to an examination of information from the builder regarding questions such as: Does the builder have training programs to educate the builder's field staff? Does the builder invest in training/education of its trade contractors? Does the builder have access to experts, in-house or external, to evaluate specialized construction problems? Is there a financial incentive for the builder's employees to earn certifications? Does the builder make use of National Association of Home Builders (NAHB) or other approved training modules?

The communications/systems factors 214 of the risk assessment scoring process assess the quality of the builder's communications systems. For example, builders may be assessed on one or more of the following issues: What types of communications equipment (for example, computers, cell phones, fax machines) are available to transfer information from construction sites 170 to the builder's office and/or to other desired locations? Is there a published project schedule that is available to all vendors? How often is the schedule updated and published? What percentage of the builder's vendors have internet access? How long does it take to transfer messages about problems/solutions to relevant parties? What provisions exist in the filed operations to disseminate construction information to interested parties?

The customer service factors 215 comprise an assessment of issues such as: How often and at what stages are customers (homeowners) who move into homes built by the builder interviewed and asked if problems exist with the home and about issues related to usage and maintenance of the home? Of homes that are already completed and that are within a warranty period, how many have warranty issues? Are any uncorrected customer service issues more than sixty days old? Are there many different types of customer service issues raised by the homeowners or are most of the problems related to a small number of issues? Customer service factors such as post-warranty issues or anomalies with a building may also be included.

The data tracking factors 216 comprise an assessment of the systems available to the builder for storing, retrieving, transferring, and integrating various types of information associated with the builder's construction projects. For example, in some embodiments, information of interest comprises statistical operational information that may exist in the form of reports, engineering and construction information such as blueprints, and customer service documentation. Questions of interest may comprise how long it takes to retrieve desired information and how information items are tracked, verified, and archived for use in trends analysis and other quality-enhancing information analyses.

The prior claims factors 217 may comprise an assessment of how well the builder has handled past claims and litigation to minimize exposure to risk. For example, the assessment may consider whether the builder has been successful at resolving multi-party complaints, if faced with such complaints, without allowing the issues to escalate. Data may also include past performance of vendors, material suppliers, and design professionals. Furthermore, the scope of the prior claims factors 217 may be expanded to include current active claims.

The safety factors 218 may comprise an assessment of the builder's compliance with OSHA-governed measurements for the safety of workers. In some embodiments, the safety factors 218 assessment further considers issues such as whether the builder has procedures in place to limit and/or to control the presence of visitors onsite and/or to limit homeowners' ability to perform construction or modifications to a structure in the project before sign-off by the builder.

The legal/contracts/insurance factors 219 may comprise an assessment of the existence of documents that limit the builder's risk by transferring liability to others and/or by otherwise limiting financial responsibility in a claim. For example, a builder who sub-contracts at least some operations, such as framing or roofing, is exposed to a lower legal risk than is a builder who performs these operations. An assessment of legal/contracts/insurance factors 219 may furthermore assess the builder's ability to contractually transfer certain claims risks to vendors by use of indemnification provisions within contracts, or requirements for vendors to quickly repair problems they created during the construction. Other examples of legal/contracts/insurance factors 219 comprise legal processes which a builder uses to respond quickly to post-warranty claims, potential and active litigation, and methods that the builder uses to assess such factors. With regard to contracts, the ability to clearly dictate to each vendor performing work their obligations of inspection, acceptance of prior work, and following plans, specifications and the like may also be assessed.

The results from the assessments of the various factors 211-219 may be transmitted to the scorecard analysis module 180 for integration in order to generate an overall builder risk assessment score 195. In some embodiments, the assessments of the individual factors 211-219 are expressed as numerical scores that may be used as factors in a calculation of the builder risk assessment score 195 and may also be reported individually in the builder risk assessment report 190.

The factors 211-219 may influence the calculation of the builder risk assessment score 195 to varying degrees. For example, in some embodiments where the nine factors 211-219 depicted in FIG. 2 are used, the factors may be weighted equally and may each contribute approximately 11% of the overall builder risk assessment score 195. In other embodiments, other systems of weighting may be applied in calculating the overall builder risk assessment score 195. For example, in one embodiment, the following ranges of weightings may be used: 5-10% from the design factors 211, 50-75% from the process/construction quality factors 212, 5-10% from the builder knowledge factors 213, 5-10% from the communications/systems factors 214, 5-10% from the customer service factors 215, 3-5% from the data tracking factors 216, 2-5% from the prior claims factors 217, 3-5% from the safety programs factors 218, and 5-10% from the legal contracts/insurance factors 219. In other embodiments, other systems of integrating factors for determining a builder risk assessment score 195 may be implemented to reflect potential risk associated with insuring a builder and/or to express a level of quality that allows for comparison of the builder with other builders.

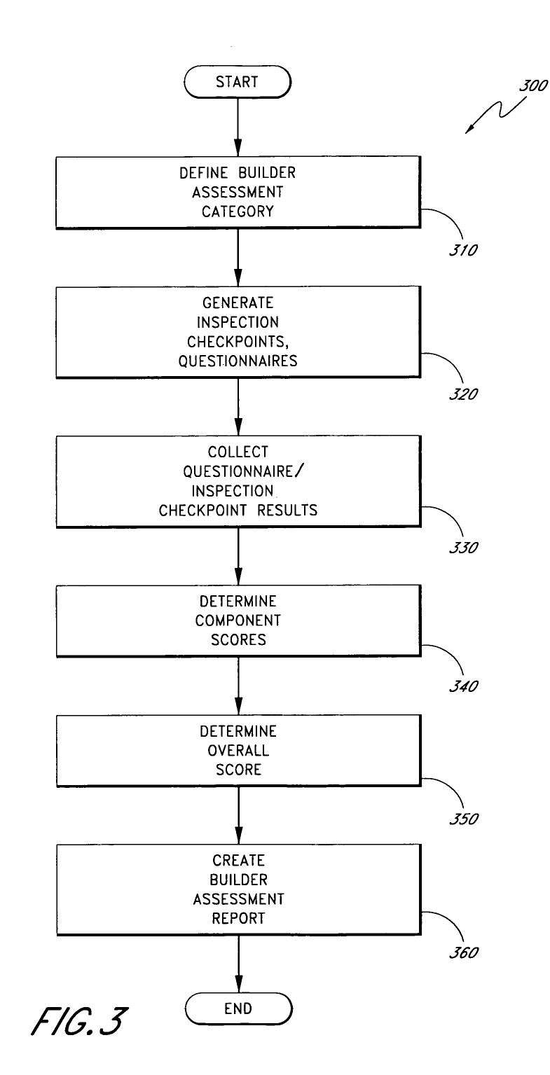

FIG. 3 is a flowchart that describes one embodiment of a process 300 to generate a builder assessment score 195 and a builder risk assessment report 190. As depicted in FIG. 3, the process 300 begins at a start state and moves to state 310, where the scorecard generation engine 120 receives from the input interface 110 preliminary information obtained about the builder and, more particularly, about the construction project(s) for which the builder desires an assessment.

The scorecard generation engine 120 uses the preliminary information to allow the scorecard generation engine's 120 customization rules 125 to construct appropriate questionnaire modules 150 and an appropriate checkpoint inspection list module 160 for performing the assessment. Customizing a set of questionnaires and inspection checkpoints based on factors such as size of the builder's project, type of units to be built, types of materials to be used, and other construction characteristics of the project allows the builder risk assessment system 100 to calculate a risk assessment score 195 that may focus on issues relevant for the given project(s) and may be meaningfully compared to scores 195 assessed for other builders.

Moving on to state 320, the customization rules 125 use the information about the builder, as well as data stored in the questionnaire repository 130 and in the checkpoints repository 140, to generate one or more customized questionnaire modules 150 and one or more customized checkpoint inspection list modules 160 for executing the customized builder risk assessment.

Moving on to state 330, the questionnaire modules 150 obtain responses to the one or more compiled questionnaires. Builder data input 105 in response to the questionnaires may be communicated to the questionnaire modules 150 using one or more of a wide variety of communications technologies, such as an interactive computer-based form presented via World Wide Web, using the Internet or other computer network, or a non-interactive computer-based version of the one or more questionnaires that may be completed and transmitted using any of a variety of computer file transport protocols. Furthermore, the builder data input 105 may be transmitted to the builder risk assessment system 100 by facsimile, via telephone, using wireless transmission technologies, using paper copies of the questionnaires that may be delivered personally or sent by mail, orally in an in-person interview, or using any of a wide variety of other communications methods.

Still in state 330, the checkpoint inspection list module 160 provides the one or more customized checkpoint inspection lists generated by the customization rules 125 for use by one or more inspectors for on-site inspections of one or more construction sites 170 that are representative of the builder's quality of construction practices for the type of project being assessed.

In one embodiment, the checkpoint list module 160 may be implemented using a portable computer device, such as a hand-held personal digital assistant (PDA), that the inspector may take to the construction sites being inspected. The portable computer device may provide a user interface that lists the selected inspection checkpoints and that allows the inspector to record observations regarding the checkpoints. The checkpoint list module 160 may compile the results of the inspector's observations while the inspector is at the construction site, or may provide the data recorded by the inspector to the scorecard analysis module 180 via wired or wireless computer connection for compilation and analysis.

Checkpoints may be written using positive wording that describes correct installation and construction procedures to assist an inspector in measuring a quality or performance issue, unlike a building code that is typically written as a prescriptive standard. While building codes are often written to cover a broad range of possible conditions, checkpoints may be written as focused and narrow standards, which may apply to a specific product and/or application condition.

Moving on to state 340, the questionnaire module(s) 150 transmit the responses to the questionnaires to the scorecard analysis module 180, and the checkpoint inspection list module 160 transmits the results of the checkpoint inspections checklists to the scorecard analysis module 180 for scoring and analysis. In the embodiment shown in FIG. 3, the scorecard analysis module 180 determines component scores for the factors that are considered in the risk assessment. For example, using the example factors depicted in FIG. 2, the scorecard analysis module 180 may determine a design component score, a process/construction quality component score, a communications systems score, and so on for the nine types of factors, and/or other factors, that influence the builder risk assessment scoring. In some embodiments, in addition to or as an alternative to determining a numeric score for the various factors considered, the scorecard analysis module 180 assigns a tier level to the various factors based on the builder's assessed quality with respect to the various factors.

Moving on to state 350, the scorecard analysis module 180 uses the component scores to determine an overall risk assessment score 195 for the builder. As with the assessment of the component factors, the overall builder risk assessment score 195 may be expressed as a numerical score, such as a gradient score, as a grade, as a category or tier-level, or using another method to express the assessed overall quality of the builder and the overall risk associated with the builder's operations.

Moving on to state 360, in the embodiment shown, the process 300 creates a builder assessment report 190 for summarizing the results of the assessment. In some embodiments, the report may also comprise suggestions for improvements to the builder's operations, may comprise documentation of observed failures to meet quality construction standards, may provide information about the builder's performance relative to other builders, and may optionally include other types of related information.

A subset of the results representing higher risk may be packaged to provide a clear directive to the builder to improve certain operations, and may calculate a positive outcome if the identified improvements are made. This information may be provided, without the risk assessment calculations to provide training to individuals and/or entities responsible for causing observed anomalies and to suggest improvements of the anomalies.

The flowchart of FIG. 3 describes one embodiment of the process 300 to generate a builder assessment score 195 and a builder risk assessment report 190 as comprising various states in which various functions are carried out. As will be familiar to one of ordinary skill in the art, in other embodiments, the process 300 may be executed using a different order, configuration, or set of states, and the states of the process 300 may perform the functions differently from the embodiment of FIG. 3, without departing from the spirit of process 300.

FIG. 4 is a flowchart that depicts one embodiment of a process, which may be embodied within a computer program, for selecting a customized set of checkpoints for a builder risk assessment. As described above, in various embodiments, the builder risk assessment system 100 comprises a checkpoint repository 140 that stores information about a large number of possible construction checkpoints. The scorecard generation engine 120 may use the customization rules 125 to select a subset of the checkpoints in the checkpoints repository 140 for inclusion in the checkpoint inspection list that will be provided to a field inspector, at least in part because the full set of checkpoints may be too large for a feasible inspection, and at least in part because some of the checkpoints may not be relevant to an inspection of the builder's construction sites. For example, checkpoints relating to the proper construction of a basement are not relevant to the inspection of units that will not have basements. Checkpoints where faulty practices may allow for the introduction of moisture and the development of mold in a home may be more indicative of potential risk, and thus more relevant to a risk assessment, in a region with year-round rainfall than in a dry desert region.

The flowchart of FIG. 4 depicts one embodiment of a process 400 for selecting the customized subset of checkpoints to be provided to the field inspector. Beginning at a start state, the process 400 moves on to state 410 where the process 400 uses information about the builder and the builder's operations to filter the checkpoints in the checkpoints repository 140 based on geography, construction type, and other relevant characteristics of the builder's construction projects. In some embodiments, checkpoints that are deemed by the system to be of less relevance for the builder's type of projects are removed from consideration for inclusion in the customized inspection checkpoint list, so that the excluded checkpoints may be seen as being “filtered out.” In some embodiments, the checkpoints may be scored or ranked regarding their relevance to the builder's type of projects, and a highest ranking set of the checkpoints may be selected for inclusion in the customized inspection checkpoint list.

Moving on to state 420 of the embodiment shown in FIG. 4, the process 400 filters the remaining checkpoints, this time using stored historical information about frequency and costliness of past construction-related claims. Thus, checkpoints that are more problematic from a liability vantage point may be used to assess the builder's construction process practices. For example, when information about construction materials to be used by a builder is provided as part of the builder data input 105, the scorecard generation engine 120 may use the information to select checkpoints related to known problems with the identified construction materials, and to filter out checkpoints not historically shown to be significant with respect to an assessment of risk. In embodiments that rate the checkpoints as a method for identifying checkpoints for inclusion in a customized list, checkpoints that are commonly associated with construction-related claims may be rated more highly than checkpoints that are not thus associated.

Moving on to state 430 of the embodiment shown in FIG. 4, the process 400 selects from amongst the remaining checkpoints a set of checkpoints representing a specified dollar amount of potential risk per unit of the builder's project. For example, in one embodiment, each checkpoint in the checkpoints repository 140 is associated with an estimated dollar amount of potential cost for repairs if the checkpoint item is improperly constructed. Making use of these estimated potential costs, the scorecard generation engine 120 selects from amongst the checkpoints that remain after the filtering processes of states 410 and 420 a set of checkpoints representing a specified dollar amount of potential risk, depicted in FIG. 4 as $X. For example, in one embodiment, checkpoints totaling an estimated potential cost of $100,000 per unit are selected for generating an inspection checkpoint list to guide an assessment of the builder's construction processes and construction quality. In other embodiments, different dollar amounts may be specified as a selection parameter for inspection checkpoints. Using a standardized dollar amount of potential risk to guide field inspections allows for a more accurate comparison of builder quality and builder risk across a broad range of builder types. In other embodiments, no fixed dollar amount is used to guide selection of the checkpoints to be inspected.

The flowchart of FIG. 4 describes one embodiment of the process 400 for selecting the customized subset of checkpoints to be provided to the field inspector as comprising various states in which various functions are carried out. As will be familiar to one of ordinary skill in the art, in other embodiments, the process 400 may be executed using a different order, configuration, or set of states, and the states of the process 400 may perform the functions differently from the embodiment of FIG. 4, without departing from the spirit of process 400.

FIG. 5 is a flowchart that depicts one embodiment of a process 500, which may be embodied within a computer program, to guide a set of field inspections and generate a process component risk score for a builder risk assessment. As depicted in FIG. 5, the set of field inspections comprises inspections of at least a specified number of units, for example, at least twenty different homes or twenty different apartments, so that the inspections may examine a cross-section of units at the construction site and so that they are not unduly influenced by the construction quality of only a small set of units. Furthermore, in the embodiment shown in FIG. 5, the inspections comprise examinations of at least another specified number of instances of the checkpoints on the customized checkpoint list, again, so that the inspection results may not be unduly influenced by the construction quality of a small number of examples of a checkpoint in question. For example, in one embodiment, at least ten instances of a given checkpoint are inspected, such as ten instances of fireblocking installation around chimney and duct openings, in order to assess the builder's average performance on the checkpoint task.

Referring now to the flowchart in FIG. 5, the process 500 to conduct field inspections for a builder risk assessment determines, at state 510, if the specified number of units, denoted here by the letter “M,” have already been inspected. If M units in the project have already been inspected, the process 500 determines, at state 540, if at least a specified number, denoted here by the letter “N,” of inspections have been completed for the checkpoints on the customized checkpoint list.

If at least one of the checkpoints on the list has had less than N inspections, the process 500 selects a checkpoint, at state 520, from the list with less than N inspections completed. At state 530, a field inspector performing the inspection is prompted to perform the selected checkpoint inspection and to record the result of the inspection.

Moving back to state 510, the process 500 again determines whether M units have been inspected. If M units in the project have not yet been inspected, the process 500 again selects a checkpoint from the customized checkpoint inspection list, and in state 530, prompts the field inspector to perform the inspection and to record the result of the inspection.

Thus, the process 500 progresses amongst the states 510, 520, 530, and 540 until the field inspector has inspected and recorded results for N instances of each checkpoint on the list and has, in the course of the inspections, inspected checkpoints in at least M different units of the builder's project.

When the process 500 determines, in state 540, that N inspections have been made for the checkpoints on the customized list, the process 500 progresses to state 550 where the process 500 calculates a risk occurrence factor for the checkpoints on the list. The risk occurrence factor expresses a measure of frequency with which the checkpoint was observed to expose the builder and/or the insurer to a potential risk of liability. In one embodiment, the risk occurrence factor for a checkpoint is calculated by dividing the number of times that the inspection revealed an unsatisfactory example of the construction practice being assessed by the number of instances of the checkpoint that were inspected. For example, if ten inspections were made for flashing installed around a window frame, and if one of the inspections revealed an unsatisfactory installation, the risk occurrence factor for the checkpoint would be 0.1. In other embodiments, different measures and/or different methods of calculation may be used to determine a level of compliance with construction quality standards.

When the process 500 has calculated a risk occurrence factor for each checkpoint on the list, the process 500 progresses to state 560 and calculates a measure of risk occurrence per year for each checkpoint. In one embodiment, the process 500 uses the risk occurrence factor calculated in state 550 together with stored statistical information about the frequency and cost of claims being brought forth for faulty practices associated with the checkpoint type, in order to calculate the projected risk occurrence per year for each checkpoint.

Moving on to state 570, the process 500 uses the risk occurrence per year for each checkpoint to calculate for the builder's projects and a total projected risk amount per unit for the builder. Moving on to state 580, using the total projected risk amount per unit, the process determines an overall process component risk score that is indicative of the projected risk associated with the builder's quality of construction practices. Embodiments that calculate a risk amount per unit may allow for comparison of relative risk levels amongst builders with widely varying sizes of projects.

The process component risk score, which is based on the results of the physical field inspections, may be used by the scorecard analysis module 180 of the builder risk assessment system 100 to help calculate an overall builder risk assessment score 195. In some embodiments, the process component risk score may also be reported within the builder risk assessment report 190. Checkpoints for which three or more instances of unsatisfactory building practices are observed during risk assessment inspections may be documented and reported so that the builder has an opportunity to correct the faulty construction observed. In some embodiments, observations of less than a specified number of conditions where a checkpoint was unsatisfactory may be removed from the statistical calculation. For example, less than three unsatisfactory occurrences of a given checkpoint may not denote a statistically accurate repeated condition that may be predicted to exist in that same percentage of buildings, and may therefore be dropped from the calculation.

The flowchart of FIG. 5 describes one embodiment of the process 500 to conduct a set of field inspections and generate a process component risk score for a builder risk assessment as comprising various states in which various functions are carried out. As will be familiar to one of ordinary skill in the art, in other embodiments, the process 500 may be executed using a different order, configuration, or set of states, and the states of the process 500 may perform the functions differently from the embodiment of FIG. 5, without departing from the spirit of process 500.

In addition to the occurrence factors described above, a legal risk factor or other modifier may be applied to the risk assessed for the checkpoints, heightening or lessening an overall process component risk score. For example, if ten of ten buildings inspected are discovered to contain an anomaly related to reinforcement steel placed too close to soil, the occurrence factor would be one hundred percent, and the associated projected risk occurrence may be calculated by multiplying the number of buildings constructed by the repair cost of anomaly. An adjustment may be made to this calculation based on a predicted legal risk of the anomaly being discovered and/or generating a claim, which may serve to lower the overall risk. For example, if there is a one-in-ten chance of the deficiency being discovered, then the occurrence factor may be multiplied by the legal risk discovery factor of one-tenth to achieve a lower overall assessment of risk.

Although the foregoing systems and methods have been described in terms of certain preferred embodiments, other embodiments will be apparent to those of ordinary skill in the art from the disclosure herein. Additionally, other combinations, omissions, substitutions and modifications will be apparent to the skilled artisan in view of the disclosure herein. While certain embodiments of the inventions have been described, these embodiments have been presented by way of example only, and are not intended to limit the scope of the inventions. Indeed, the novel methods and systems described herein may be embodied in a variety of other forms without departing from the spirit thereof. The accompanying claims and their equivalents are intended to cover such forms or modifications as would fall within the scope and spirit of the invention.

1. A computer-implemented method for generating a risk assessment of a builder, the method comprising:
providing a database that comprises a master set of questions and inspection checkpoints for use in assessing builder risk;
obtaining input about a builder and about projects associated with the builder;
using the input about the builder and the projects to select from the database a subset of questions to present to the builder, and a subset of inspection checkpoints to use to inspect one or more construction projects of the builder;
receiving responses to the subsets of questions from the builder, and storing said responses within computer storage;
recording within computer storage results of the subset of inspection checkpoints as applied to one or more construction projects of the builder; and
using at least the responses to the subsets of questions and the results of the subset of inspection checkpoints to generate a risk assessment score of the builder.

2. The computer-implemented method of claim 1, wherein the input about the projects comprises information about a geographical location of the projects.

3. The computer-implemented method of claim 1, wherein the input about the projects comprises information about construction methods and materials planned for the projects.

4. The computer-implemented method of claim 1, wherein the input about the projects comprises information regarding at least one of the set consisting of: types of the projects, sizes of the projects, geographical location of the projects, construction methods and materials planned for the projects, and special features of the projects.

5. The computer-implemented method of claim 1, further comprising reporting the builder's risk assessment score.

6. The computer-implemented method of claim 5, wherein using the input to select a subset of questions and inspection checkpoints comprises selecting questions and inspection checkpoints for assessing component factors, the component factors comprising at least one of the set consisting of: design issues, communications systems, builder knowledge, construction practices, customer service, data tracking, prior and active claims, legal contracts and insurance, and safety programs.

7. The computer-implemented method of claim 6, wherein reporting the builder's risk assessment score further comprises reporting scores for the component factors that influence the builder risk assessment.

8. The computer-implemented method of claim 6, further comprising calculating the risk assessment score as a weighted combination of the scores for the component factors.

9. A system for determining a builder risk assessment score, comprising:
a user interface for user entry of data regarding a builder and building projects associated with the builder;
a database comprising a master set of questions and inspection checkpoints for conducting builder risk assessments;
a first component configured to receive from the user interface the data regarding the builder and the builder's projects and to select from the database a subset of questions to present to the builder, and a subset of inspection checkpoints to use to inspect construction the builder; and
a second component that calculates a risk assessment score for the builder based at least in part on builder responses to the subset of questions and results of the subset of inspection checkpoints.

10. The system of claim 9, wherein the database further comprises at least one of the set consisting of: information about proper construction practices associated with the checkpoints, historical information about costs associated with repairing construction faults associated with the checkpoints, information about a statistical frequency of liability claims regarding the checkpoints; and a measure of relevance of proper construction technique for the checkpoints to a risk assessment for projects of various types and various geographical locations.

11. The system of claim 9, wherein the database further comprises questions for assessing the builder regarding at least one of the set consisting of: design issues, communications systems, builder knowledge, customer service, data tracking practices, prior and active claims history, insurance and other legal documents, and safety programs implemented.

12. The system of claim 9, wherein the first component is further configured to select the subset of questions and inspection checkpoints based at least in part on the input data.

13. The system of claim 12, wherein the first component is further configured to select the subset of questions and inspection checkpoints based at least in part on a set of customization rules.

14. A method for performing a builder assessment, comprising:
receiving information about a builder and about projects associated with the builder;
obtaining additional information about the builder and about at least one of the builder's projects, wherein the additional information comprises results from a physical inspection of the builder's project and information about design aspects of the project and the builder's communications and customer service systems; and
determining a builder assessment score, based at least in part on the obtained information.

15. The method of claim 14, further comprising determining for the builder at least one of the set consisting of: a risk assessment grade, a risk assessment category, and a risk assessment tier-level.

16. The method of claim 14, wherein determining a builder assessment score comprises assigning a numeric score to a plurality of factors associated with builder quality.

17. The method of claim 14, further comprising obtaining information from more than one project of the builder to determine a sample of the builder's operations.
